(19) United States
(12) Patent Application Publication
(10) Pub. No.: US 2024/0265291 A1
(43) Pub. Date: Aug. 8, 2024

(54) CLASSIFYING INCORPORATION METRICS

(71) Applicant: Adobe Inc., San Jose, CA (US)

(72) Inventors: Charles Robert John Matthews, Edinburgh (GB); Thomas Stanley Dalton, Scotland (GB); Harinder Singh Sandhu, Edinburgh (GB); Adrian John O'Lenske, Dunblane (GB)

(73) Assignee: Adobe Inc., San Jose, CA (US)

(21) Appl. No.: 18/104,946

(22) Filed: Feb. 2, 2023

(51) Int. Cl. G06N 20/00

(52) U.S. Cl. CPC G06N 20/00

(57) ABSTRACT

In implementations of systems for classifying incorporation metrics, a computing device implements a classification system to receive code data describing information associated with a set of new code defining new functionality for an application. The set of new code is to be incorporated into a set of existing code defining existing functionality of the application. The classification system processes the code data using a machine learning model trained on training data to generate classifications of incorporation metrics for sets of new code defining new functionalities to be incorporated into sets of existing code defining existing functionalities. A classification of an incorporation metric for the set of new code is output using the machine learning model based on processing the code data. The classification system generates an indication of the classification of the incorporation metric for the set of new code for display in a user interface.

### BACKGROUND

A set of existing code defining existing functionality of an application is controlled (e.g., by versions) to prevent unauthorized changes to the set of existing code which could degrade the existing functionality of the application. In order to add new functionality to the application, a request to incorporate a set of new code defining the new functionality into the set of existing code is generated. In response to the request, the set of new code is reviewed/analyzed based on various criteria. If the various criteria are satisfied, then the set of new code is incorporated into the set of existing code to add the new functionality to the application.

### SUMMARY

Techniques and systems for classifying incorporation metrics are described. In an example, a computing device implements a classification system to receive code data describing information associated with a set of new code defining new functionality for an application. The set of new code is to be incorporated into a set of existing code defining existing functionality of the application.

For example, the classification system processes the code data using a machine learning model trained on training data to generate classifications of incorporation metrics for sets of new code defining new functionalities to be incorporated into sets of existing code defining existing functionalities. A classification of an incorporation metric for the set of new code is output using the machine learning model based on processing the code data. In one example, the classification system generates an indication of the classification of the incorporation metric for the set of new code for display in a user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ digital systems and techniques for classifying incorporation metrics as described herein.

FIG. 2 depicts a system in an example implementation showing operation of a classification module for classifying incorporation metrics.

FIG. 3 illustrates a representation of code data describing information associated with a set of new code.

FIG. 4 illustrates a representation of examples of classifications of incorporation metrics for sets of new code.

FIG. 5 illustrates a representation of receiver operating characteristic curves depicting relationships between false positive classifications and true positive classifications of incorporation metrics.

FIG. 6 illustrates a representation of segment information for incorporation metrics.

FIG. 7 is a flow diagram depicting a procedure in an example implementation in which a classification of an incorporation metric for a set of new code is generated automatically.

FIG. 8 is a flow diagram depicting a procedure in an example implementation in which a classification of an incorporation metric for a set of new code is generated in response to receiving a request to incorporate the set of new code into a set of existing code.

FIG. 9 illustrates an example system that includes an example computing device that is representative of one or more computing systems and/or devices for implementing the various techniques described herein.

### DETAILED DESCRIPTION

### Overview

Conventional systems for incorporating sets of new code defining new functionalities for applications into sets of existing code defining existing functionalities of the applications are not capable of inferring information related to a process of incorporating a set of new code into a set of existing code before starting the process. For example, conventional systems are not capable of inferring that the set of new code will not be successfully incorporated into the set of existing code until after resources are consumed in a failed attempt to incorporate the set of new code into the set of existing code which is inefficient. In order to overcome this limitation, techniques and systems for classifying incorporation metrics are described.

In one example, a computing device implements a classification system to receive code data describing information associated with a set of new code that defines new functionality for an application. In this example, the set of new code is to be incorporated into a set of existing code defining existing functionality of the application. For example, the information associated with the set of new code includes information such as code coverage for the set of new code, a number of lines added to the set of existing code by the set of new code, a number of lines removed from the set of existing code by the set of new code, a number of comment lines, a number of non-comment lines, a timestamp of a request to incorporate the set of new code into the set of existing code, code coverage for the set of existing code, a number of lines included in the set of existing code, and so forth.

Consider an example in which the classification system implements a trained machine learning model to process the code data in order to classify incorporation metrics for the set of new code. For example, the machine learning model is trained on training data to generate classifications of incorporation metrics for sets of new code defining new functionalities to be incorporated into sets of existing code defining existing functionalities. In this example, the training data describes outcomes from thousands of requests to incorporate sets of new code into sets of existing code such as whether or not the sets of new code were incorporated into the sets of existing code, a number of days between requests to incorporate the sets of new code into the sets of existing code and a date of incorporation of the sets of new code into the sets of existing code or a date of abandonment of the sets of new code, a number of days between requests to incorporate the sets of new code into the sets of existing code and a first approval of the sets of new code, a number of comments received by the sets of new code in reviews, etc. In an example, the machine learning model includes a histogram-based gradient boosting classifier, and the classification system implements one machine learning model trained on the training data to generate a classification of one incorporation metric for the set of new code based on the code data.

For example, the classification system processes the code data using a first histogram-based gradient boosting classifier trained on the training data to generate a classification of a first incorporation metric, a second histogram-based gradient boosting classifier trained on the training data to generate a classification of a second incorporation metric, a third histogram-based gradient boosting classifier trained on the training data to generate a classification of a third incorporation metric, and a fourth histogram-based gradient boosting classifier trained on the training data to generate a classification of a fourth incorporation metric. In some examples, the first incorporation metric specifies that the set of new code is not incorporated into the set of existing code within a first threshold number of days; the second incorporation metric specifies that the set of new code does not receive a first approval within a second threshold number of days; the third incorporation metric specifies that the set of new code is not incorporated into the set of existing code; and the fourth incorporation metric specifies that the set of new code receives more than a threshold number of comments in a review.

The classification system leverages outputs of the first, second, third, and fourth histogram-based gradient boosting classifiers to generate a classification summary for the set of new code for display in a user interface. For example, the classification summary includes binary classifications of the first, second, third, and fourth incorporation metrics. Consider an example in which the binary classification of the third incorporation metric conveys that the set of new code is not incorporated into the set of existing code. Unlike conventional systems, the described systems are capable of inferring that the set of new code will not be incorporated into the set of existing code before consuming resources in a failed attempt to incorporate the set of new code into the set of existing code. As a result, it is possible to intervene such that consumption of the resources is avoidable which is not possible using conventional systems. Additionally, the described systems for classifying incorporation metrics are capable of identifying an actionable change to increase a likelihood that the set of new code is incorporated into the set of existing code such as dividing the set of new code into smaller sets of code which is also not possible using conventional systems.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Environment

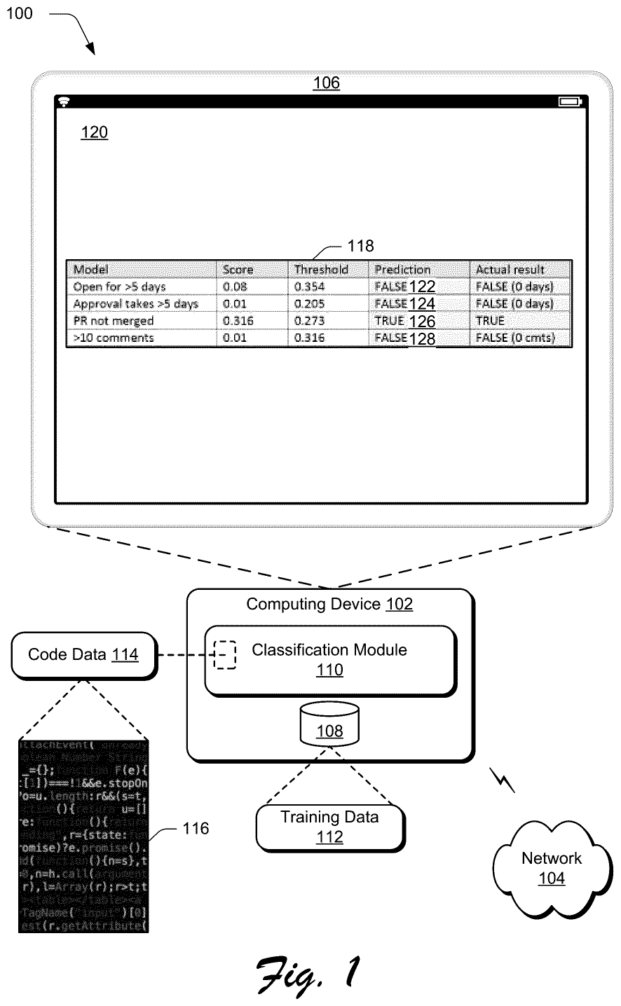

FIG. 1 is an illustration of an environment 100 in an example implementation that is operable to employ digital systems and techniques as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

The illustrated environment 100 also includes a display device 106 that is communicatively coupled to the computing device 102 via a wired or a wireless connection. A variety of device configurations are usable to implement the computing device 102 and/or the display device 106. For instance, the computing device 102 includes a storage device 108 and a classification module 110.

The storage device 108 is illustrated to include training data 112 describing outcomes from thousands of requests to incorporate sets of new code into sets of existing code such as whether or not the sets of new code were incorporated into the sets of existing code, a number of days between requests to incorporate the sets of new code into the sets of existing code and a date of incorporation of the sets of new code into the sets of existing code or a date of abandonment of the sets of new code, a number of days between requests to incorporate the sets of new code into the sets of existing code and a first approval of the sets of new code, a number of comments received by the sets of new code in reviews, etc. In one example, the classification module 110 includes a machine learning model and the classification module 110 trains the machine learning model to generate classifications of incorporation metrics for sets of new code using the training data 112. As used herein, the term “machine learning model” refers to a computer representation that is tunable (e.g., trainable) based on inputs to approximate unknown functions.

By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning. For example, the machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

In some examples, the machine learning model includes a histogram-based gradient boosting classifier or multiple histogram-based gradient boosting classifiers. For instance, the classification module 110 trains a histogram-based gradient boosting classifier on the training data 112 for each incorporation metric to be classified for the sets of new code. In one example, the classification module 110 trains a first histogram-based gradient boosting classifier on the training data 112 to generate binary classifications of a first incorporation metric specifying that the sets of new code are not incorporated into the sets of existing code within a first threshold number of days; the classification module 110 trains a second histogram-based gradient boosting classifier on the training data 112 to generate binary classifications of a second incorporation metric specifying that the sets of new code do not receive first approvals within a second threshold number of days; the classification module 110 trains a third histogram-based gradient boosting classifier on the training data 112 to generate binary classifications of a third incorporation metric specifying that the sets of new code are not incorporated into the sets of existing code; the classification module 110 trains a fourth histogram-based gradient boosting classifier on the training data 112 to generate binary classifications of a fourth incorporation metric specifying that the sets of new code receive more than a threshold number of comments in a review, and so forth.

The classification module 110 is illustrated as having, receiving, and/or transmitting code data 114 describing information associated with a set of new code 116. For example, the set of new code 116 defines new functionality for an application, and the set of new code 116 is to be incorporated into a set of existing code which defines existing functionality of the application. In an example, the application is an application for editing digital content, and the new functionality is a new blending technique for vector objects defined by the set of new code 116. The code data 114 describes a variety of information associated with the set of new code 116 such as code coverage for the set of new code 116, a number of lines added to the set of existing code by the set of new code 116, a number of lines removed from the set of existing code by the set of new code 116, a number of comment lines, a number of non-comment lines, a timestamp of a request to incorporate the set of new code 116 into the set of existing code, code coverage for the set of existing code, a number of lines included in the set of existing code, etc.

In an example, the classification module 110 processes the code data 114 using the first histogram-based gradient boosting classifier trained on the training data 112 to generate a classification of the first incorporation metric, the second histogram-based gradient boosting classifier trained on the training data 112 to generate a classification of the second incorporation metric, the third histogram-based gradient boosting classifier trained on the training data 112 to generate a classification of the third incorporation metric, and the fourth histogram-based gradient boosting classifier trained on the training data 112 to generate a classification of the fourth incorporation metric. In this example, the classification module 110 leverages outputs of the first, second, third, and fourth histogram-based gradient boosting classifiers to generate a classification summary 118 for the set of new code 116 which is displayed in a user interface 120 of the display device 106. As shown, the classification summary 118 includes an indication 122 of the classification of the first incorporation metric, an indication 124 of the classification of the second incorporation metric, an indication 126 of the classification of the third incorporation metric, and an indication 128 of the classification of the fourth incorporation metric.

For instance, the indication 122 conveys that the request to incorporate the set of new code 116 into the set of existing code is not pending/open for more than five days from the timestamp of the request. The indication 124 conveys that the set of new code 116 does not receive a first approval more than five days from the timestamp of the request. The indication 128 conveys that the set of new code 116 does not receive more than 10 comments in a review. For example, the indication 128 does not provide insight into the seemingly conflicting information conveyed by the indications 122, 124 (e.g., that the request is not pending more than five days from the timestamp of the request and that the set of new code 116 does not receive a first approval more than five days from the timestamp of the request). In this example, the indication 126 provides the insight into the information conveyed by the indications 122, 124 by conveying that the set of new code 116 is not incorporated into the set of existing code.

By generating the classification summary 118 which includes the indication 126 in this manner, it is possible for the classification module 110 to intervene in response to receipt of the request to incorporate the set of new code 116 into the set of existing code, e.g., by exposing the information which indicates that the set of new code 116 will not be incorporated into the set of existing code before any resources are utilized in an attempt to incorporate the set of new code 116 into the set of existing code. For example, when the request to incorporate the set of new code 116 into the set of existing code is received, the classification module 110 causes the third histogram-based gradient boosting classifier trained on the training data 112 to process the code data 114 and generate the indication 126. Additionally or alternatively, the classification module 110 is capable of intervening in response to receipt of the request to incorporate the set of new code 116 into the set of existing code, e.g., by generating and displaying an indication of an actionable change (e.g., splitting the set of new code 116 into smaller sets of code) to modify the classification indicated by the indication 126 such that the set of new code 116 is incorporated into the set of existing code. In some examples, the classification module 110 generates the indication 126 as including the indication of the actionable change which the classification module 110 determines based on a derivative of the classification (e.g., illustrated as “FALSE” but computed using a numerical output of the third histogram-based gradient boosting classifier) with respect to the code data 114. This is not possible in conventional systems which are not capable of inferring that the set of new code 116 is not incorporated into the set of existing code until at least some resources are utilized in a failed attempt to incorporate the set of new code 116 into the set of existing code. These conventional systems are also not capable of generating the indication of the actionable change which (if performed) increases a likelihood that the set of new code 116 is incorporated into the set of existing code.

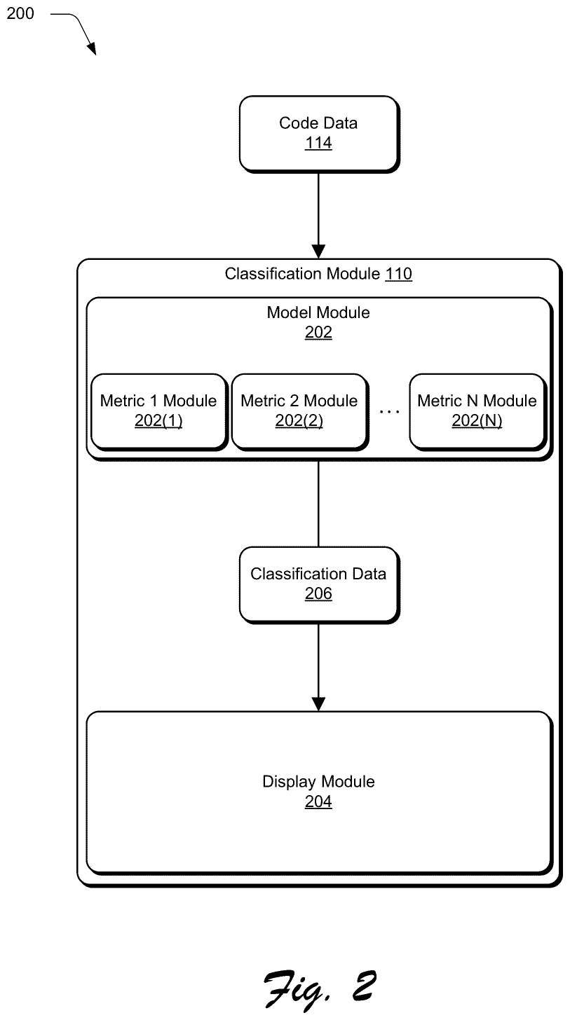

FIG. 2 depicts a system 200 in an example implementation showing operation of a classification module 110 for classifying incorporation metrics. The classification module 110 is illustrated to include a model module 202 and a display module 204. As illustrated in FIG. 2, the model module 202 includes a metric 1 module 202(1), a metric 2 module 202(2), a metric 3 module 202(3) (not shown), a metric 4 module 202(4) (not shown), and a metric N module 202(N) which are each representative of a histogram-based gradient boosting classifier trained on the training data 112 to generate a classification of an incorporation metric for the set of new code 116. For example, the metric 1 module 202(1) includes a histogram-based gradient boosting classifier trained on the training data 112 to generate a binary classification of a first incorporation metric for the set of new code 116; the metric 2 module 202(2) includes a histogram-based gradient boosting classifier trained on the training data 112 to generate a binary classification of a second incorporation metric for the set of new code 116; the metric 3 module 202(3) includes a histogram-based gradient boosting classifier trained on the training data 212 to generate a binary classification of a third incorporation metric for the set of new code 116; the metric 4 module 202(4) includes a histogram-based gradient boosting classifier trained on the training data 212 to generate a binary classification of a fourth incorporation metric for the set of new code 116; and the metric N module 202(N) includes a histogram-based gradient boosting classifier trained on the training data 112 to generate a binary classification of an Nth incorporation metric for the set of new code 116.

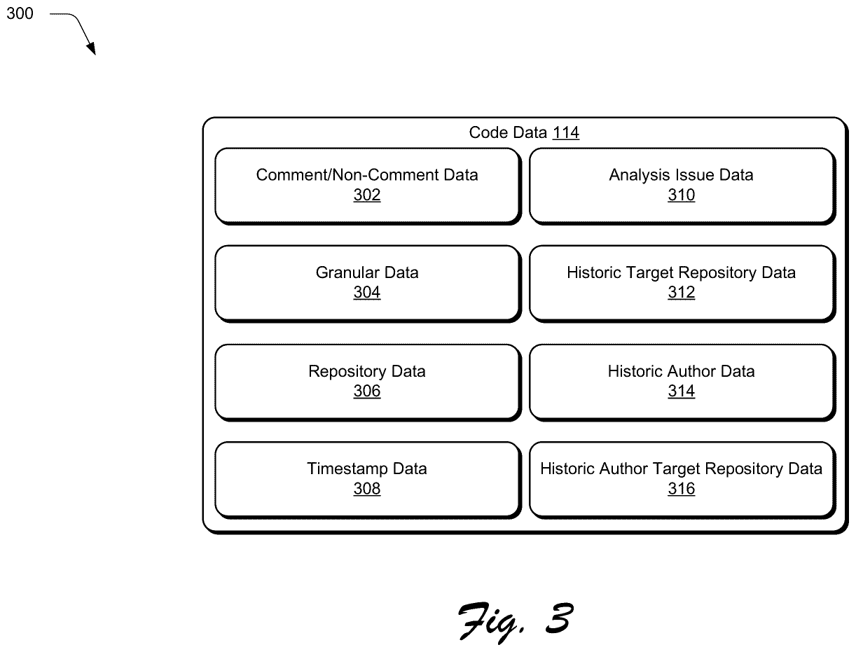

FIG. 3 illustrates a representation 300 of code data 114 describing information associated with a set of new code 116. For instance, the model module 202 is illustrated as receiving the code data 114 as an input. As illustrated in the representation 300, the code data 114 describes a variety of different types of information associated with the set of new code 116.

For example, the code data 114 includes comment/non-comment data 302 that describes code coverage for the set of new code 116, a number of comment lines added to the set of existing code by the set of new code 116, a number of non-comment lines added to the set of existing code by the set of new code 116, a number of comment lines removed from the set of existing code by the set of new code 116, and a number of non-comment lines removed from the set of existing code by the set of new code 116. In some examples, the code data 114 includes granular data 304 describing information such as a total number of files, numbers of files having particular file extensions (e.g., .JSON, .JAVA, .SNAP, etc.), and numbers of lines of code changed by the set of new code 116 for the files having the particular file extensions. In an example, the code data 114 includes repository data 306 which describes overall code coverage for code included in a repository that includes the set of existing code and a number of lines of the code included in the repository.

As shown in the representation 300, the code data 114 includes timestamp data 308 in one example. For instance, the timestamp data 308 describes a timestamp of the request to incorporate the set of new code 116 into the set of existing code which includes a time of a day, a day of a week, etc. In the illustrated example, the code data 114 includes analysis issue data 310. The analysis issue data 310 describes results of an analysis of the set of new code 116 including a number of analysis issues found in the analysis which are separated into different issue categories.

The code data 114 is illustrated to include historic target repository data 312 that describes historical averages (e.g., mean and variance) of values described by the comment/non-comment data 302, the granular data 304, the repository data 306, the timestamp data 308, and/or the analysis issue data 310 taken with respect to a target code repository including a number of lines of code included in the target code repository, code coverage for the target code repository, and a complete set of requests to incorporate sets of new code into sets of existing code included in the target code repository. In some examples, the code data 114 includes historic author data 314 which describes historical averages (e.g., mean and variance) of the values described by the comment/non-comment data 302, the granular data 304, the repository data 306, the timestamp data 308, and/or the analysis issue data 310 taken with respect to all historical requests to incorporate sets of new code into sets of existing code associated with an author of the set of new code 116. In similar examples, the code data 114 includes historic author target repository data 316 describing historical averages (e.g., mean and variance) of the values described by the comment/non-comment data 302, the granular data 304, the repository data 306, the timestamp data 308, and/or the analysis issue data 310 taken with respect to all historical requests to incorporate sets of new code into sets of existing code included in the target repository that are associated with the author of the set of new code 116.

The model module 202 receives the code data 114 and implements the metric 1 module 202(1) to process the code data 114 using the histogram-based gradient boosting classifier trained on the training data 112 to generate the binary classification of the first incorporation metric for the set of new code 116. For example, the model module 202 implements the metric 2 module 202(2) to process the code data 114 using the histogram-based gradient boosting classifier trained on the training data 112 to generate the binary classification of the second incorporation metric for the set of new code 116; the model module 202 implements the metric 3 module 202(3) (not shown) to process the code data 114 using the histogram-based gradient boosting classifier trained on the training data 112 to generate the binary classification of the third incorporation metric for the set of new code 116; and the model module 202 implements the metric 4 module 202(4) (not shown) to process the code data 114 using the histogram-based gradient boosting classifier trained on the training data 112 to generate the binary classification of the fourth incorporation metric for the set of new code 116. Similarly, the model module 202 implements the metric N module 202(N) to process the code data 114 using the histogram-based gradient boosting classifier trained on the training data 112 to generate the binary classification of the Nth incorporation metric for the set of new code 116. In one example, the model module 202 generates classification data 206 describing the binary classification of the first incorporation metric for the set of new code 116, the binary classification of the second incorporation metric for the set of new code 116, the binary classification of the third incorporation metric for the set of new code 116, the binary classification of the fourth incorporation metric for the set of new code 116, and the binary classification of the Nth incorporation metric for the set of new code 116.

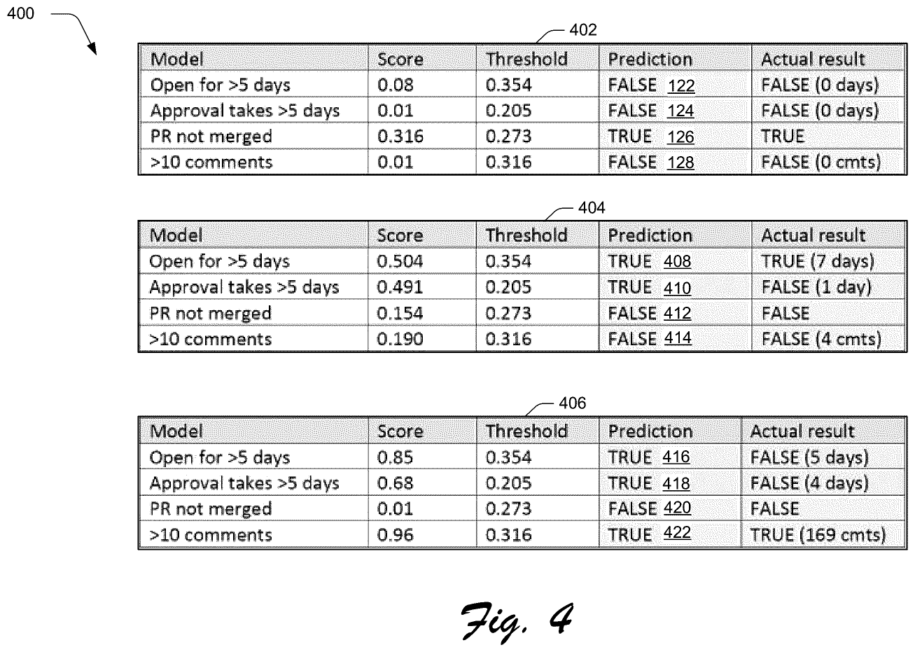

FIG. 4 illustrates a representation 400 of examples of classifications of incorporation metrics for sets of new code. For example, the display module 204 receives and processes the classification data 206 to generate classification summaries 402-406 for sets of new code which are illustrated in the representation 400. The display module 204 processes the classification data 206 to generate a classification summary 402 for the set of new code 116 in a first example.

In the first example, the classification summary 402 includes the indication 122 which conveys that the request to incorporate the set of new code 116 into the set of existing code is not pending for more than five days from the timestamp of the request. The classification summary 402 also includes a score of 0.08 and a threshold of 0.354 associated with the indication 122. For instance, the score of 0.08 corresponds to an output of the histogram-based gradient boosting classifier included in the metric 1 module 202(1) based on processing the code data 114.

The threshold of 0.354 is an adjustable value for comparison with the score of 0.08 to classify the first incorporation metric for the set of new code 116. Since the score of 0.08 is less than the threshold of 0.354 in this first example, the binary classification of the first incorporation metric for the set of new code 116 is false. In another example, if the score of 0.08 was greater than the threshold of 0.354, then the binary classification of the first incorporation metric for the set of new code 116 would be true. For example, the classification summary 402 includes an actual result associated with the indication 122 which is also false. Thus, in this first example, the classification module 110 correctly classified the first incorporation metric for the set of new code 116.

Continuing the first example, the classification summary 402 includes the indication 124 which conveys that the set of new code 116 does not receive a first approval more than five days from the timestamp of the request. The classification summary 402 includes a score of 0.01 and a threshold of 0.205 associated with the indication 124. For example, the score of 0.01 corresponds to an output of the histogram-based gradient boosting classifier included in the metric 2 module 202(2) based on processing the code data 114, and the binary classification of the second incorporation metric for the set of new code 116 is false because the score of 0.01 is less than the threshold of 0.205. An actual result associated with the indication 124 is also false, and the classification module 110 correctly classified the second incorporation metric for the set of new code 116.

The classification summary 402 includes the indication 126 which conveys that the set of new code 116 is not incorporated into the set of existing code. A score of 0.316 associated with the indication 126 represents an output from the histogram-based gradient boosting classifier included in the metric 3 module 202(3) based on processing the code data 114. The score of 0.316 is compared to a threshold of 0.273 in order to classify the third incorporation metric for the set of new code 116. For instance, the binary classification of the third incorporation metric for the set of new code 116 is true because the score of 0.316 is greater than the threshold of 0.273. Since an actual result associated with the indication 126 is also true, the classification module 110 correctly classified the third incorporation metric for the set of new code 116.

Continuing the first example, the classification summary 402 includes the indication 128 which conveys that the set of new code 116 does not receive more than 10 comments in a review. For instance, a score of 0.01 and a threshold of 0.316 are associated with the indication 128. In one example, the score of 0.01 corresponds to an output of the histogram-based gradient boosting classifier included in the metric 4 module 202(4) based on processing the code data 114. The binary classification of the fourth incorporation metric for the set of new code 116 is false because the score of 0.01 is less than the threshold of 0.316. An actual result associated with the indication 128 is also false, and the classification module 110 correctly classified the fourth incorporation metric for the set of new code 116.

As shown, the display module 204 processes the classification data 206 to generate a classification summary 404 for the set of new code 116 in a second example. In the second example, the classification summary 404 includes an indication 408 which conveys that the request to incorporate the set of new code 116 into the set of existing code is pending for more than five days from the timestamp of the request. For instance, the classification summary 404 includes a score of 0.504 associated with the indication 408 and the threshold of 0.354. The score of 0.504 corresponds to an output of the histogram-based gradient boosting classifier included in the metric 1 module 202(1) based on processing the code data 114. Since the score of 0.504 is greater than the threshold of 0.354 in this second example, the binary classification of the first incorporation metric for the set of new code 116 is true. In one example, the classification summary 404 includes an actual result associated with the indication 408 which is also true. In this example, the classification module 110 correctly classified the first incorporation metric for the set of new code 116.

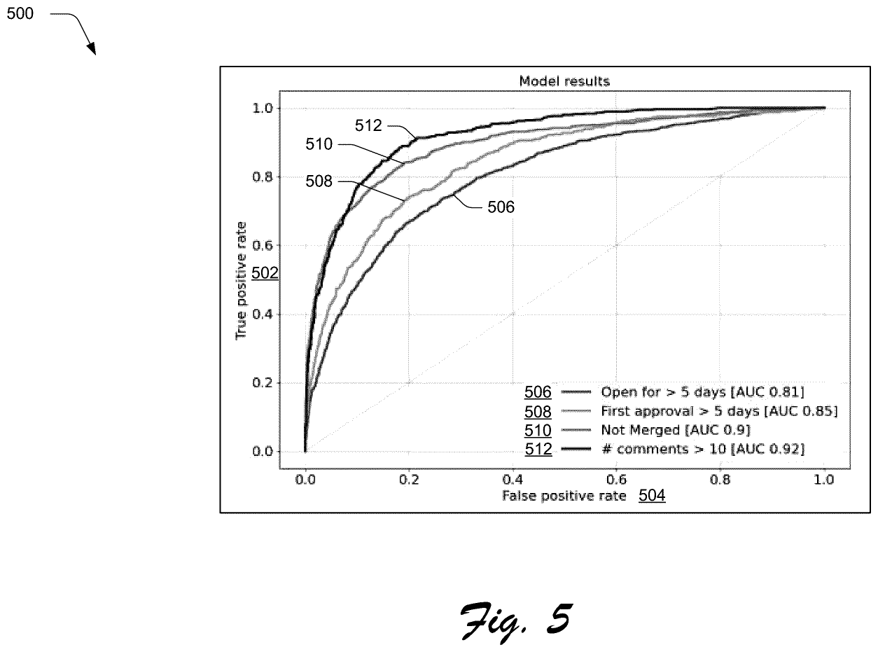

Continuing the second example, the classification summary 404 includes an indication 410 which conveys that the set of new code 116 does receive a first approval more than five days from the timestamp of the request. As shown, the classification summary 404 includes a score of 0.491 associated with the indication 410 and the threshold of 0.205. In an example, the score of 0.491 corresponds to an output of the histogram-based gradient boosting classifier included in the metric 2 module 202(2) based on processing the code data 114. In this example, the binary classification of the second incorporation metric for the set of new code 116 is true because the score of 0.491 is greater than the threshold of 0.205. An actual result associated with the indication 410 is false. Accordingly, the classification module 110 incorrectly classified the second incorporation metric for the set of new code 116, and the indication 410 represents a false positive classification. It is possible to increase or decrease a rate of false positive classifications by the classification module 110 which is described in detail with respect to FIG. 5 below.

The classification summary 404 includes an indication 412 which conveys that the set of new code 116 is incorporated into the set of existing code. For example, the classification summary 404 includes a score of 0.154 associated with the indication 412 which represents an output from the histogram-based gradient boosting classifier included in the metric 3 module 202(3) based on processing the code data 114. The score of 0.154 is compared to the threshold of 0.273 in order to classify the third incorporation metric for the set of new code 116. The binary classification of the third incorporation metric for the set of new code 116 is false because the score of 0.154 is less than the threshold of 0.273. For example, an actual result associated with the indication 412 is also false, and the classification module 110 correctly classified the third incorporation metric for the set of new code 116.

Continuing the second example, the classification summary 404 includes an indication 414 which conveys that the set of new code 116 does not receive more than 10 comments in a review. For example, the classification summary 404 also includes a score of 0.19 which is associated with the indication 414 as well as the threshold of 0.316. In this example, the score of 0.19 corresponds to an output of the histogram-based gradient boosting classifier included in the metric 4 module 202(4) based on processing the code data 114. The binary classification of the fourth incorporation metric for the set of new code 116 is false because the score of 0.19 is less than the threshold of 0.316. For instance, an actual result associated with the indication 414 is also false. Thus, the classification module 110 correctly classified the fourth incorporation metric for the set of new code 116 in this example.

In a third example, the display module 204 processes the classification data 206 to generate a classification summary 406 for the set of new code 116. In this third example, the classification summary 406 includes indications 416, 418, 420, and 422 having corresponding scores of 0.85, 0.68, 0.01, and 0.96, respectively. For example, the classification module 110 compares the scores of 0.85, 0.68, 0.01, and 0.96 to the corresponding thresholds of 0.354, 0.205, 0.273, and 0.316, respectively. Based on these comparisons, the classification module 110 incorrectly classifies the first incorporation metric as true, incorrectly classifies the second incorporation metric as true, correctly classifies the third incorporation metric as false, and correctly classifies the fourth incorporation metric as true for the set of new code 116.

FIG. 5 illustrates a representation 500 of receiver operating characteristic curves depicting relationships between false positive classifications and true positive classifications of incorporation metrics. The representation 500 illustrates relationships between true positive rates 502 and false positive rates 504. For example, a first curve 506 is for the first incorporation metric; a second curve 508 is for the second incorporation metric; a third curve 510 is for the third incorporation metric; and a fourth curve 512 is for the fourth incorporation metric. In this example, each of the curves 506-512 illustrates a predictive power of the classification module 110 for a corresponding one of the incorporation metrics as a sensitivity threshold is changed.

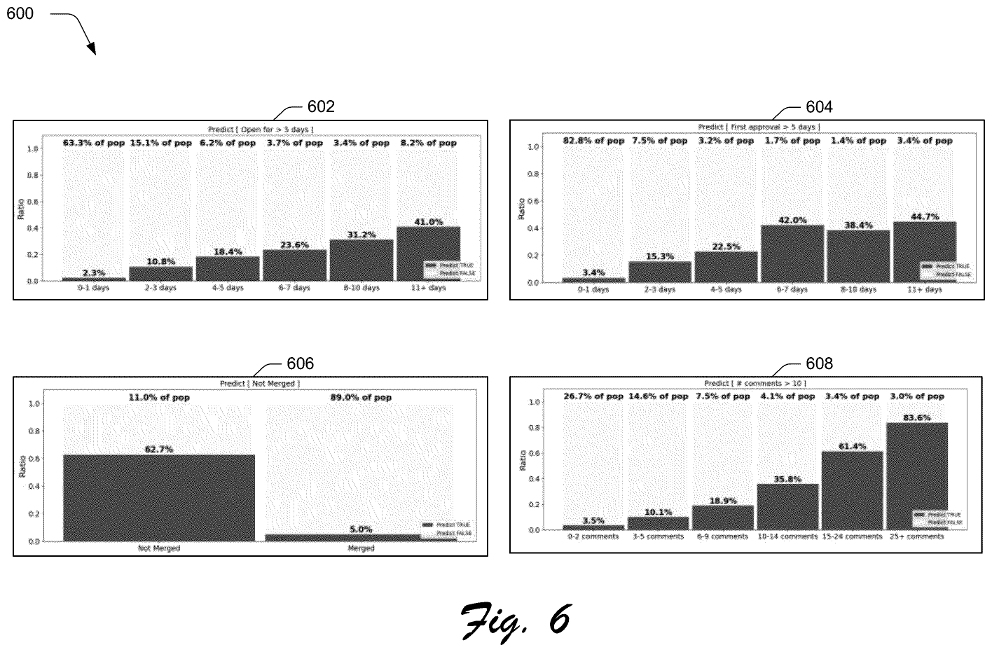

FIG. 6 illustrates a representation 600 of segment information for incorporation metrics. As shown, the representation 600 includes a first summary 602 for the first incorporation metric; a second summary 604 for the second incorporation metric; a third summary 606 for the third incorporation metric; and a fourth summary 608 for the fourth incorporation metric. In an example, the training data 112 describes outcomes of about 54,131 requests to incorporate sets of new code into sets of existing code. For example, the summaries 602-608 summarize outcomes of about 6,015 requests to incorporate sets of new code into sets of existing code which are not included in the training data 112.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

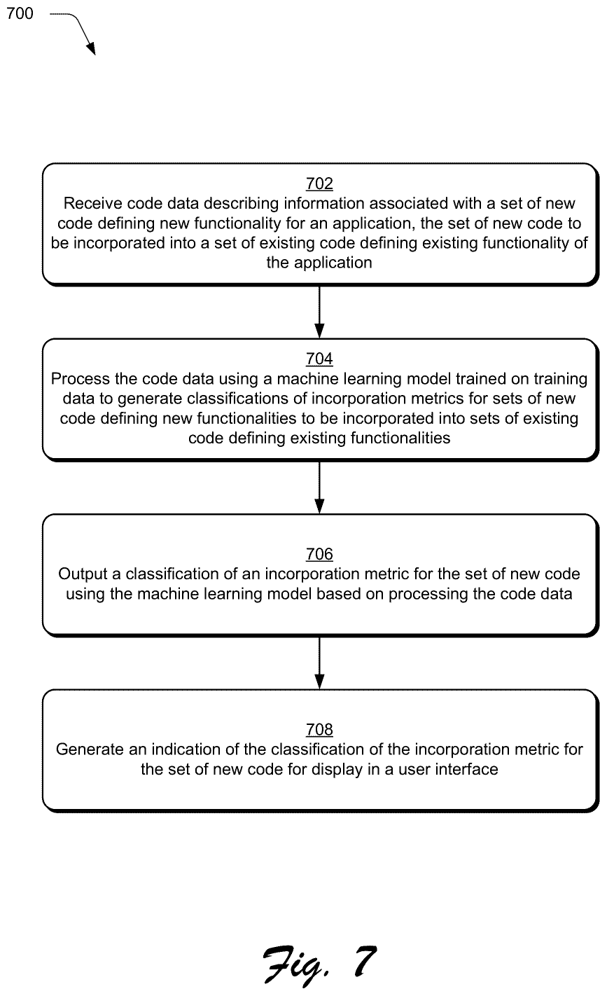

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-6. FIG. 7 is a flow diagram depicting a procedure 700 in an example implementation in which a classification of an incorporation metric for a set of new code is generated automatically.

Code data is received describing information associated with a set of new code defining new functionality for an application, the set of new code to be incorporated into a set of existing code defining existing functionality of the application (block 702). For example, the computing device 102 implements the classification module 110 to receive the code data. The code data is processed using a machine learning model trained on training data to generate classifications of incorporation metrics for sets of new code defining new functionalities to be incorporated into sets of existing code defining existing functionalities (block 704). In an example, the classification module 110 implements the machine learning model to process the code data.

A classification of an incorporation metric for the set of new code is output using the machine learning model based on processing the code data (block 706). In some examples, the classification module 110 implements the machine learning model to output the classification of the incorporation metric for the set of new code. An indication of the classification of the incorporation metric for the set of new code is generated for display in a user interface (block 708). The classification module 110 generates the indication of the classification of the incorporation metric in an example.

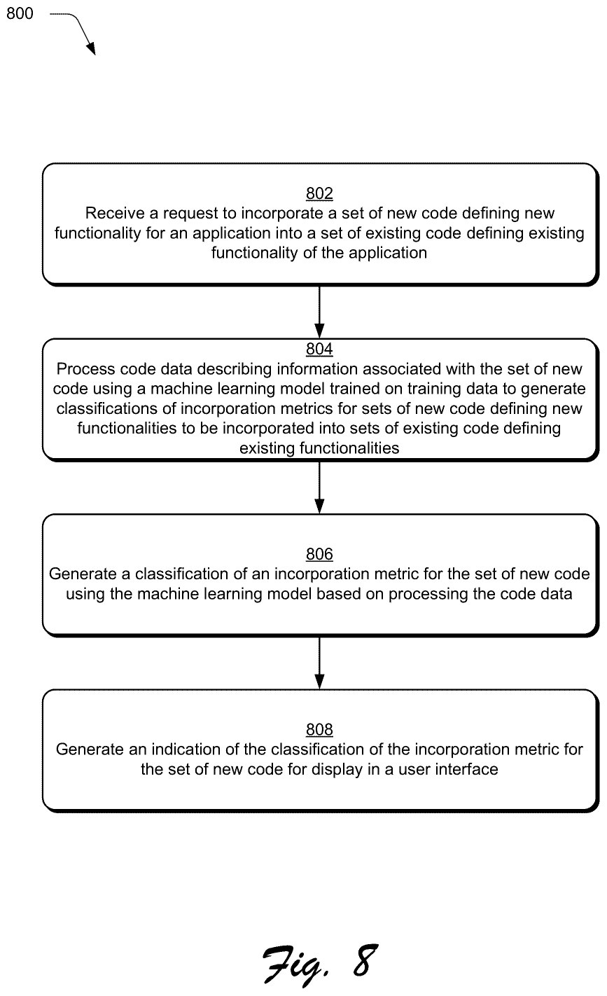

FIG. 8 is a flow diagram depicting a procedure 800 in an example implementation in which a classification of an incorporation metric for a set of new code is generated in response to receiving a request to incorporate the set of new code into a set of existing code. A request to incorporate a set of new code defining new functionality for an application into a set of existing code defining existing functionality of the application is received (block 802). In one example, the computing device 102 implements the classification module 110 to receive the request.

Code data describing information associated with the set of new code is processed using a machine learning model trained on training data to generate classifications of incorporation metrics for sets of new code defining new functionalities to be incorporated into sets of existing code defining existing functionalities (block 804). For example, the classification module 110 implements the machine learning model to process the code data. A classification of an incorporation metric for the set of new code is generated using the machine learning model based on processing the code data (block 806). In an example, the classification module 110 implements the machine learning model to generate the classification of the incorporation metric for the set of new code. An indication of the classification of the incorporation metric for the set of new code is generated for display in a user interface (block 808). The computing device 102 implements the classification module 110 to generate the indication of the classification of the incorporation metric for the set of new code in one example.

### Example System and Device

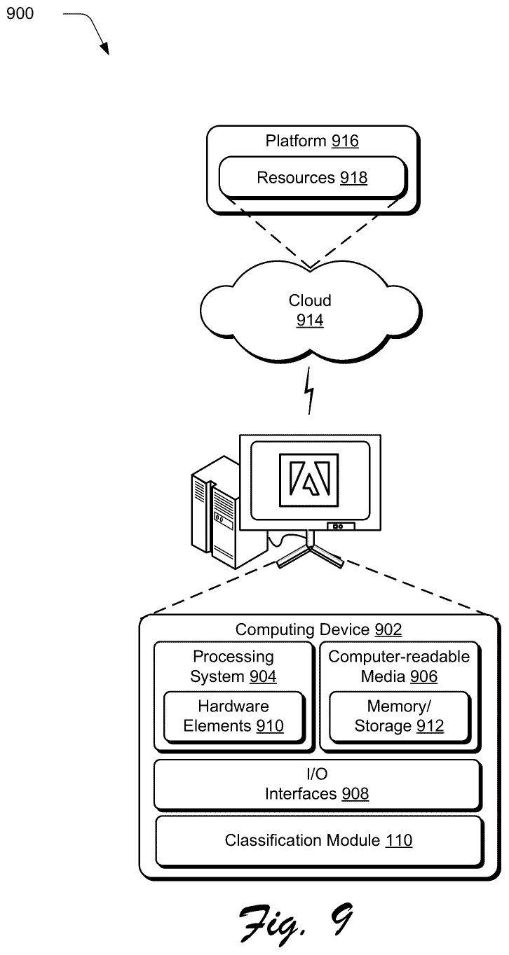

FIG. 9 illustrates an example system 900 that includes an example computing device that is representative of one or more computing systems and/or devices that are usable to implement the various techniques described herein. This is illustrated through inclusion of the classification module 110. The computing device 902 includes, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interfaces 908 that are communicatively coupled, one to another. Although not shown, the computing device 902 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware elements 910 that are configured as processors, functional blocks, and so forth. This includes example implementations in hardware as an application specific integrated circuit or other logic device formed using one or more semiconductors. The hardware elements 910 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 906 is illustrated as including memory/storage 912. The memory/storage 912 represents memory/storage capacity associated with one or more computer-readable media. In one example, the memory/storage 912 includes volatile media (such as random access memory (RAM)) and/or nonvolatile media (such as read only memory (ROM), Flash memory, optical disks, magnetic disks, and so forth). In another example, the memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 910. For example, the computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices 902 and/or processing systems 904) to implement techniques, modules, and examples described herein.

The techniques described herein are supportable by various configurations of the computing device 902 and are not limited to the specific examples of the techniques described herein. This functionality is also implementable entirely or partially through use of a distributed system, such as over a “cloud” 914 as described below.

The cloud 914 includes and/or is representative of a platform 916 for resources 918. The platform 916 abstracts underlying functionality of hardware (e.g., servers) and software resources of the cloud 914. For example, the resources 918 include applications and/or data that are utilized while computer processing is executed on servers that are remote from the computing device 902. In some examples, the resources 918 also include services provided over the Internet and/or through a subscriber network, such as a cellular or Wi-Fi network.

The platform 916 abstracts the resources 918 and functions to connect the computing device 902 with other computing devices. In some examples, the platform 916 also serves to abstract scaling of resources to provide a corresponding level of scale to encountered demand for the resources that are implemented via the platform. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

### CONCLUSION

Although implementations of systems for classifying incorporation metrics have been described in language specific to structural features and/or methods, it is to be understood that the appended claims are not necessarily limited to the specific features or methods described. Rather, the specific features and methods are disclosed as example implementations of systems for classifying incorporation metrics, and other equivalent features and methods are intended to be within the scope of the appended claims. Further, various different examples are described and it is to be appreciated that each described example is implementable independently or in connection with one or more other described examples.

What is claimed is:

1. A method comprising:
receiving, by a processing device, code data describing information associated with a set of new code defining new functionality for an application, the set of new code to be incorporated into a set of existing code defining existing functionality of the application;
processing, by the processing device, the code data using a machine learning model trained on training data to generate classifications of incorporation metrics for sets of new code defining new functionalities to be incorporated into sets of existing code defining existing functionalities;
outputting, by the processing device, a classification of an incorporation metric for the set of new code using the machine learning model based on processing the code data; and
generating, by the processing device, an indication of the classification of the incorporation metric for the set of new code for display in a user interface.

2. The method as described in claim 1, wherein the machine learning model includes a histogram-based gradient boosting classifier.

3. The method as described in claim 1, wherein the classification is a binary classification.

4. The method as described in claim 1, wherein the incorporation metric is at least one of a metric specifying that the set of new code is not incorporated into the set of existing code within a first threshold number of days, a metric specifying that the set of new code does not receive a first approval within a second threshold number of days, a metric specifying that the set of new code is not incorporated into the set of existing code, or a metric specifying that the set of new code receives more than a threshold number of comments in a review.

5. The method as described in claim 1, wherein the information associated with the set of new code includes at least one of code coverage for the set of new code, a number of lines to be added to the set of existing code, or a number of lines to be removed from the set of existing code.

6. The method as described in claim 1, wherein the information associated with the set of new code includes at least one of a number of non-comment lines, a number of comment lines, or a timestamp of a request to incorporate the set of new code into the set of existing code.

7. The method as described in claim 1, wherein the information associated with the set of new code includes at least one of code coverage for the set of existing code or a number of lines included in the set of existing code.

8. The method as described in claim 1, wherein the indication of the classification includes an indication of an actionable change to modify the classification.

9. The method as described in claim 8, wherein the actionable change is determined based on a derivative of the classification with respect to the code data.

10. A system comprising:
a memory component; and
a processing device coupled to the memory component, the processing device to perform operations comprising:
receiving a request to incorporate a set of new code defining new functionality for an application into a set of existing code defining existing functionality of the application;
processing code data describing information associated with the set of new code using a machine learning model trained on training data to generate classifications of incorporation metrics for sets of new code defining new functionalities to be incorporated into sets of existing code defining existing functionalities;
generating a classification of an incorporation metric for the set of new code using the machine learning model based on processing the code data; and
generating an indication of the classification of the incorporation metric for the set of new code for display in a user interface.

11. The system as described in claim 10, wherein the information associated with the set of new code includes at least one of a number of non-comment lines, a number of comment lines, or a timestamp of the request.

12. The system as described in claim 10, wherein the incorporation metric is at least one of a metric specifying that the set of new code is not incorporated into the set of existing code within a first threshold number of days, a metric specifying that the set of new code does not receive a first approval within a second threshold number of days, a metric specifying that the set of new code is not incorporated into the set of existing code, or a metric specifying that the set of new code receives more than a threshold number of comments in a review.

13. The system as described in claim 10, wherein the classification is a binary classification.

14. The system as described in claim 10, wherein the machine learning model includes a histogram-based gradient boosting classifier.

15. A non-transitory computer-readable storage medium storing executable instructions, which when executed by a processing device, cause the processing device to perform operations comprising:
receiving code data describing information associated with a set of new code defining new functionality for an application, the set of new code to be incorporated into a set of existing code defining existing functionality of the application;
processing the code data using a machine learning model trained on training data to generate classifications of incorporation metrics for sets of new code defining new functionalities to be incorporated into sets of existing code defining existing functionalities;
outputting a classification of an incorporation metric for the set of new code using the machine learning model based on processing the code data; and
generating an indication of the classification of the incorporation metric for the set of new code for display in a user interface.

16. The non-transitory computer-readable storage medium as described in claim 15, wherein the information associated with the set of new code includes at least one of a number of non-comment lines, a number of comment lines, or a timestamp of a request to incorporate the set of new code into the set of existing code.

17. The non-transitory computer-readable storage medium as described in claim 15, wherein the information associated with the set of new code includes at least one of code coverage for the set of new code, a number of lines to be added to the set of existing code, or a number of lines to be removed from the set of existing code.

18. The non-transitory computer-readable storage medium as described in claim 15, wherein the information associated with the set of new code includes at least one of code coverage for the set of existing code or a number of lines included in the set of existing code.

19. The non-transitory computer-readable storage medium as described in claim 15, wherein the machine learning model includes a histogram-based gradient boosting classifier.

20. The non-transitory computer-readable storage medium as described in claim 15, wherein the incorporation metric is at least one of a metric specifying that the set of new code is not incorporated into the set of existing code within a first threshold number of days, a metric specifying that the set of new code does not receive a first approval within a second threshold number of days, a metric specifying that the set of new code is not incorporated into the set of existing code, or a metric specifying that the set of new code receives more than a threshold number of comments in a review.
